(19) United States
(12) Patent Application Publication
(10) Pub. No.: US 2026/0208700 A1
(43) Pub. Date: Jul. 23, 2026

(54) ADAPTER FOR A WIPER SYSTEM

(71) Applicant: VALEO SYSTEMES D'ESSUYAGE, La Verriere (FR)

(72) Inventors: Stephane HOUSSAT, La Verriere (FR); Vincent GAUCHER, La Verriere (FR); Olivier JOMARD, La Verriere (FR)

(73) Assignee: VALEO SYSTEMES D'ESSUYAGE, La Verriere (FR)

(21) Appl. No.: 19/134,853

(22) PCT Filed: Dec. 11, 2023
(86) PCT No.: PCT/EP2023/085210

§ 371 Date: Jun. 2, 2025

(30) Foreign Application Priority Data
Dec. 14, 2022 (FR) FR2213403

(51) Int. Cl. B60S 1/40

(52) U.S. Cl. CPC B60S 1/4083

(57) ABSTRACT

The present invention relates to an adapter for attaching a wiper blade to a drive arm of a wiper system. The adapter includes a locking device configured to lock or unlock the adapter with respect to the drive arm and a push button carried by a tab, wherein the tab has in cross-section at least two flanks connected to each other by an elbow portion.

### TECHNICAL FIELD

The present invention relates to the field of wiper systems intended for motor vehicles, and more particularly to adapters forming part of such wiper systems.

### BACKGROUND OF THE INVENTION

Motor vehicles are commonly equipped with wiper systems that are intended to clean their glazed surfaces, and in particular their windshield. Such wiper systems comprise at least one drive arm and a wiper blade driven by the drive arm. The drive arm is connected to an electric motor of the vehicle and the wiper blade comprises at least one wiper-blade rubber intended to make contact with the glazed surface to be wiped.

In order to be able to replace the wiper blade, a connecting device is arranged between the wiper blade and the drive arm. More particularly, the connecting device comprises an adapter arranged between the drive arm and a connector connected to the wiper blade. The adapter is then secured to the drive arm and more particularly to a free end of the drive arm, such coupling being reversible in order that the wiper blade may be changed once it becomes worn out.

Adapters generally comprise a locking device, in order that their position with respect to the drive arms may be locked or unlocked.

In prior-art adapters, it is known for the locking device to comprise a flexible longitudinal tab and a push button placed at a free end of the tab, the push button making it possible to block a translational movement between the adapter and the drive arm. However, arranging the locking device, and in particular its tab, in such a manner generates substantial bulk. Specifically, it is necessary to provide sufficient space to receive it, both in a longitudinal direction and in a vertical direction. Providing such accommodation may considerably limit the room available to receive the drive arm.

### SUMMARY OF THE INVENTION

The present invention aims to overcome this drawback by providing an adapter, the shape of the tab of which is tailored to the space available within the adapter, thus allowing room to be made to receive the drive arm.

The main subject of the present invention is thus an adapter attaching a wiper blade to a drive arm of a wiper system, comprising a locking device configured to lock or unlock the adapter with respect to the drive arm and comprising a push button borne by a tab. According to the invention, the tab has in cross section at least two flanks connected to each other by a bent portion.

The adapter according to the invention makes it possible to create a link between, on the one hand, the wiper blade intended to make contact with a glazed surface of a motor vehicle, and, on the other hand, the drive arm that allows this wiper blade to be moved over the glazed surface. The adapter comprises a locking device that allows it to be blocked translationally with respect to the drive arm. Such a locking device more precisely comprises a push button and a tab, these two elements here being superposed on each other. It will thus be understood that actuation of the push button allows the tab to be deformed, by opening the flanks about an axis passing through the bent portion. The tab has, when viewed in cross section, i.e. a cross section in a plane perpendicular to a main direction of elongation of the adapter, at least two flanks that are joined by the bent portion. In other words, the tab is characterized by a sequence of at least a first flank, a bent portion and a second flank. Such a configuration of the flanks and of the bent portion allows bulk to be decreased compared with prior-art longitudinal tabs, thereby freeing up room within the adapter, while still allowing the locking or unlocking function to be performed.

According to one feature of the invention, the cross section of the tab is U-shaped.

The two flanks then form the stems of the U. Alternatively, the cross section of the tab may be V-shaped, the flanks meeting in the bent portion in such a way as to form a vertex.

According to another feature of the invention, the adapter mainly extends in a longitudinal direction L, an axis of rotation of the push button being parallel, or substantially parallel, to the longitudinal direction L.

As mentioned above, the longitudinal direction corresponds to the main direction of elongation of the adapter, i.e. to its largest dimension. Pressing on the push button causes a rotation of the tab to which it is secured. More particularly, such a rotation of the tab takes place about an axis parallel to the longitudinal direction.

According to one feature, at least the flanks of the tab predominantly extend in the longitudinal direction of the adapter. The bent portion may also extend mainly in the longitudinal direction of the adapter.

In other words, the largest dimension of the flanks of the tab extends in the main direction of elongation of the adapter. Such a feature makes it possible to free up room within the adapter.

According to one feature of the invention, the flanks have a constant cross section.

According to one feature, the adapter has a receiving housing configured to receive the drive arm, the push button being off-center with respect to a median longitudinal axis of the receiving housing.

The drive arm is able to slide within the adapter and its receiving housing until it reaches a position in which it will be secured to the adapter. The receiving housing may be considered to be split into two equal parts by a median longitudinal axis, which therefore extends parallel to the longitudinal direction. The push button is off-center with respect to such a median longitudinal axis, i.e. it is placed to one side thereof. In other words, the push button is offset with respect to the median longitudinal axis.

The adapter according to the invention may comprise a receiving cavity configured to receive a connector, the receiving housing configured to receive the drive arm being off-center with respect to the receiving cavity. The drive arm is thus laterally offset with respect to the area linking with the connector.

According to one variant, the tab protrudes from an edge of an opening present in a top wall of the adapter and into which the push button extends. The tab acts as a hinge and participates in the rotation of the push button and the blocking member that it bears.

According to another feature of the invention, the push button is interposed transversely between the bent portion and a constituent blocking member of the locking device and is configured to block the drive arm with respect to the adapter.

The blocking member is a portion of the locking device that is intended to hold the drive arm in position, via mechanical interference therewith.

According to one feature, the adapter comprises a receiving cavity configured to receive a connector, the receiving housing configured to receive the drive arm being off-center with respect to the receiving cavity. The receiving housing is thus transversely opposite the tab with respect to the push button.

The connector makes it possible to ensure a link, for example a pivoting link, with the wiper blade. This connector is housed, within the adapter, in the receiving cavity. According to one aspect, the receiving cavity is placed transversely to the center of the adapter. Conversely, the housing for receiving the drive arm is off-center with respect to these two elements, i.e. it is not aligned with them. It will thus be understood that the receiving housing is offset transversely within the adapter.

According to one feature, the adapter comprises at least one stiffening element extending at least between one of the flanks and the blocking member.

The stiffening element makes it possible to ensure the mechanical strength of the tab and to improve its resistance to stresses. Such a stiffening element is, for example, a rib. The stiffening element extends between one of the flanks on the one hand and the blocking member on the other hand. As a result, the stiffening element extends mainly in the transverse direction.

According to one feature of the invention, the tab has longitudinal dimensions of between 10 and 30 mm and transverse dimensions of between 2 and 5 mm, the adapter having longitudinal dimensions of between 70 and 150 mm and transverse dimensions of between 20 and 60 mm.

What is meant by “longitudinal dimensions” are dimensions of the tab and/or adapter measured in the main direction of elongation of the adapter, and by “transverse dimensions” dimensions of the tab and/or adapter measured in the transverse direction.

According to another feature of the invention, the tab, the push button and a main body of the adapter are integral made of the same material.

Such a feature makes manufacture easier and allows the cost of the materials used during manufacture to be decreased.

The invention further relates to a wiper system comprising a drive arm, a wiper blade, a connector and an adapter such as mentioned above.

As mentioned above, the connector and the adapter participate in securing the drive arm and the wiper blade within the wiper system. The wiper system is for example fitted to a motor vehicle.

### BRIEF DESCRIPTION OF DRAWINGS

Further features, details and advantages of the invention will become clearer on reading, on the one hand, the following description, and on the other hand, examples of embodiment that are given by way of indication and non-limitingly, with reference to the attached drawings, in which:

FIG. 1 schematically shows a perspective view of a wiper system according to the invention;

FIG. 2 schematically shows a perspective view of an adapter of the wiper system of FIG. 1;

FIG. 3 schematically shows a bottom view of the adapter of FIG. 2; and

FIG. 4 schematically shows a cross-sectional view of the adapter of FIG. 2.

The features, variants and the various embodiments of the invention may be associated with one another, in various combinations, as long as they are not mutually incompatible or mutually exclusive. In particular, it will be possible to conceive of variants of the invention which comprise only a selection of the features described below, in isolation from the other features described, if this selection of features is sufficient to confer a technical advantage and/or to differentiate the invention from the prior art.

### DETAILED DESCRIPTION OF THE INVENTION

In the figures, elements common to multiple figures have been designated by the same reference sign in all of them.

In the following detailed description, the terms “longitudinal”, “transverse” and “vertical” refer to the orientation of the adapter according to the invention. A longitudinal direction corresponds to a main direction of elongation of this adapter, this longitudinal direction being parallel to a longitudinal axis L of a coordinate system L, V, T shown in the figures. A vertical direction corresponds to a direction in which the push button and tab are superposed, this vertical direction being parallel to a vertical axis V of the coordinate system L, V, T, and this vertical axis V being perpendicular to the longitudinal axis L. Lastly, a transverse direction corresponds to a direction parallel to a transverse axis T of the coordinate system L, V, T, this transverse axis T being perpendicular to the longitudinal axis L and to the vertical axis V.

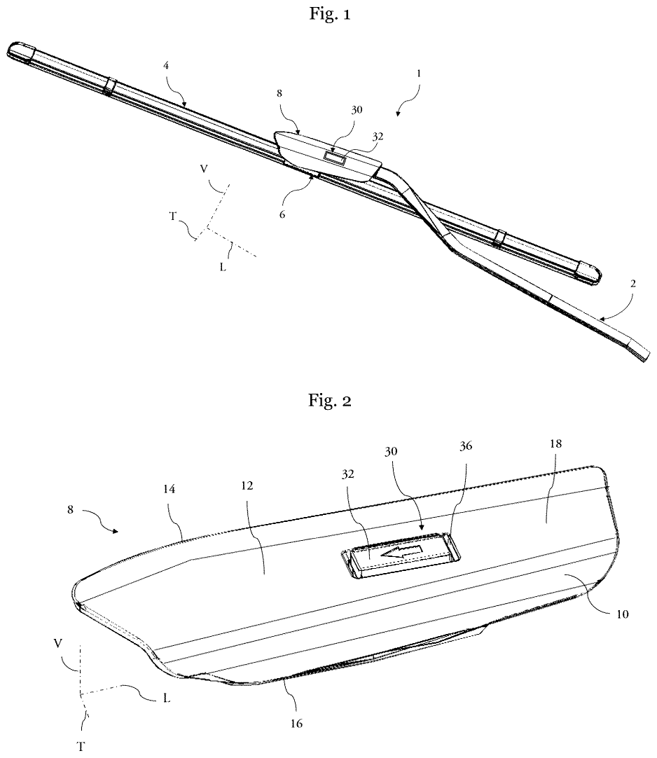

FIG. 1 thus schematically shows a wiper system 1 according to the invention. The wiper system 1 is intended to clean a glazed surface of a vehicle, for example a windshield, so as to improve the view that a driver has of the road in front of the vehicle. The wiper system 1 comprises at least one drive arm 2 bearing at one end a wiper blade 4 that mainly extends in the longitudinal direction L.

Within the wiper system 1, the drive arm 2 and the wiper blade 4 are associated with each other by means of a connection device involving a connector 6 and an adapter 8, the adapter 8 covering the connector 6. More particularly, the connector 6 is secured to the wiper blade 4 while the adapter 8 is secured to the drive arm 2, a pivoting link connecting the adapter 8 and the connector 6.

The adapter 8 will now be described in greater detail with reference to FIG. 2 to FIG. 4. The adapter 8 extends in a main direction of elongation which corresponds to a longitudinal direction L. It comprises a main body 10, which is formed from a top wall 12 and from two side walls 14, 16. The top wall 12 extends mainly in the longitudinal L and transverse T directions; it is placed between the two side walls 14, 16 and connects them to each other.

The top wall 12 has a top face 18 and a bottom face 20 that are opposite each other in a vertical direction V. As shown in FIG. 2, the top face 18 is the face exposed to air flow, when the wiper system is installed on a vehicle.

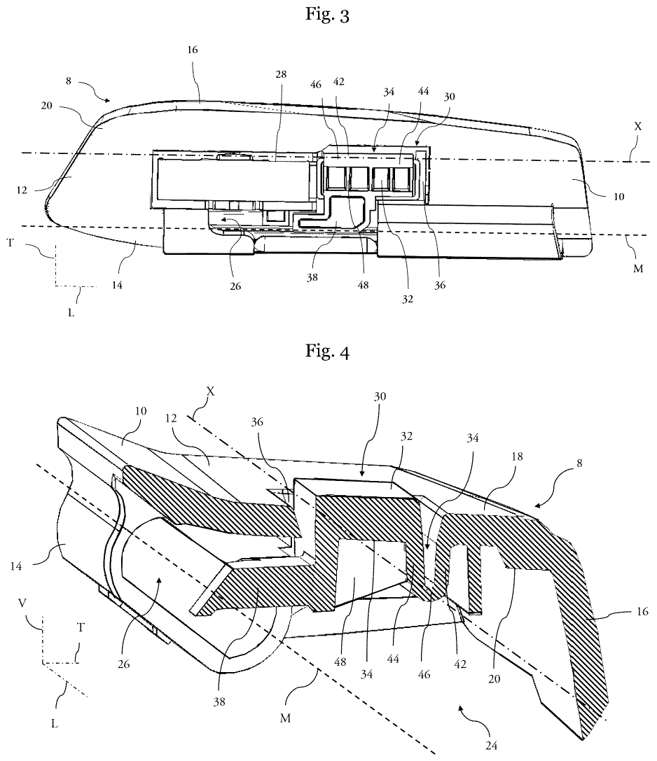

The bottom face 20 is intended to face the connector 6, the wiper blade 4 and the drive arm 2. To this end, the top wall 12 and one of the side walls are placed so as to define between them an internal space 24 of the adapter 8, the internal space 24 in particular being shown in FIG. 3 and FIG. 4.

The internal space 24 has within it a number of indentations intended to house components of the wiper system 1, and which are particularly shown in FIG. 3. By way of indentations, the internal space 24 in particular comprises a receiving housing 26 configured to receive the drive arm 2 and a receiving cavity 28 configured to receive the connector 6.

The receiving cavity 28 extends from the bottom face 20 and away therefrom. In shape it is a rectangular parallelepiped and is centered transversely within the internal space 24; in other words, the receiving cavity 28 is substantially equidistant from each of the side walls 14, 16 of the adapter 8. The receiving cavity 28 receives the connector 6 such that the latter becomes interlocked therein when it is integrated into the wiper system 1.

The receiving housing 26 extends along one of the side walls 14, 16 and is partly bounded by the latter. In other words, the receiving housing 26 extends along a transverse side of the adapter 8. Consequently, the receiving housing 26 is off-center within the adapter 8, and a median longitudinal axis M of the receiving housing 26 is therefore closer to one of the side walls 14, 16 than to the other. The drive arm 2 is able to slide within the adapter 8 until it comes into abutment against its receiving housing 26.

The receiving housing is for example formed from at least two tunnels configured to slidably receive an end part of the arm.

The adapter 8 comprises, in order to lock onto the drive arm 2, a locking device 30. The role of this locking device 30 is to block a translational movement of the drive arm 2 with respect to the adapter 8. The locking device 30 comprises several elements for this purpose.

The locking device 30 in particular comprises a push button 32, particularly shown in FIG. 2 and FIG. 4, and a tab 34 that is shown in FIG. 3 and FIG. 4. The push button 32, the tab 34 and the main body 10 of the adapter 8 may, in order to make it easier to manufacture, be integral made of the same material.

The push button 32 protrudes slightly from the top wall 12 of the adapter 8. Alternatively, its top face may lie in the same plane as the top face 12 of the adapter. The push button is more specifically placed within an opening 36 formed in the top wall 12. The push button 32 here has a substantially rectangular shape. It is placed, in the top wall 12, substantially equidistant from the two side walls 14, 16. As a result, the push button 12 is transversely offset with respect to the median longitudinal axis M of the housing 26 for receiving the drive arm 2, which it participates in locking in position.

As may be seen in FIG. 4, the push button 32 is borne by the tab 34. This tab 34, which will be described in greater detail below, extends from an edge of the top wall 12 bordering the opening 36 to the push button 32, the latter bearing a blocking member 38 intended to block at least one longitudinal movement of the adapter 8 with respect to the drive arm 2. The blocking member 38, which forms part of the locking device 30, is here a plate, an L-shape of which is complementary to a corner of the cavity 28 for receiving the connector 6, as may be seen in FIG. 3. The blocking member 38 is intended to be inserted into a notch in the drive arm 2, thus blocking any longitudinal movement between the adapter 8 and the arm.

The push button 32 is configured to be able to be actuated by a person using the wiper system 1. Thus, when pressure is exerted on the push button 32, it is able to retract at least partially into the internal space 24 of the adapter 8. Such a movement is made possible by the shape of the tab 34, in particular by the presence of the flanks 42, 44 joined to each other by the bent portion 46. When the push button 32 is pressed, the flanks 42, 44 move away from each other via a rotation about an axis of rotation X parallel to the longitudinal direction L and passing through the bent portion 46. The tab 34 acts as a hinge that, when the push button 32 is pressed, permits the push button 32 to rotate. Thus, and as mentioned above, pressing on the push button 32 causes a reversible deformation of the tab 34 about the axis of rotation X, the rotation of the tab 34 allowing an abutment against the drive arm 2 of the blocking member 38 to be retracted from the latter, thus freeing a translational movement between the adapter 8 and the drive arm 2.

The shape of the tab 34 also allows the blocking member 38 to retake its initial position, in which it is ready to block at least one translational movement between the adapter 8 and the drive arm 2.

The tab 34 will now be described in greater detail with reference to FIG. 3 and FIG. 4. The tab 34 has longitudinal dimensions of between 10 and 30 mm and transverse dimensions of between 2 and 5 mm, while the adapter 8 of which it forms part has longitudinal dimensions of between 70 and 150 mm and transverse dimensions of between 20 and 60 mm.

According to the invention, the tab 34 has, when viewed in cross section, at least two flanks 42, 44 that are connected to each other by a bent portion 46. Such a cross section, which is cut in a vertical-transverse plane, corresponds for example to the cross-sectional view in FIG. 4.

It will be noted that the thickness of the flanks 42, 44 and of the bent portion 46 is between 0.5 and 1.5 mm.

The tab 34 here has two flanks 42, 44, namely a first flank 42 and a second flank 44; however, a tab 34 comprising three or four flanks connected pairwise by bent portions could also be employed, without departing from the scope of the invention. The successive arrangement of the first flank 42, the bent portion 46 and the second flank 44 gives the cross section of the tab 34 a U-shape; alternatively, however, a tab 34 having a V-shaped cross section could also employed, the bent portion then corresponding to the vertex of such a V.

The first flank 42 here extends from the edge of the top wall 12 bordering the opening 36, while the second flank 44 stems from a transverse face of the push button 32. The first flank 42, the second flank 44 and the bent portion 46 all lie within the internal space 24 of the adapter 8. The flanks 42, 44 of the tab 34 mainly lie in a vertical and longitudinal plane of the adapter 8. As is in particular shown in FIG. 4, they lie in planes substantially perpendicular to a plane in which the top wall 12 lies. The flanks 42, 44 here have a constant cross section in these planes.

In order to increase the mechanical strength of the tab 34, the adapter 8 comprises at least one stiffening element 48. The stiffening element 48 may for example take the form of a rib. As shown in FIG. 3, the adapter 8 has five stiffening elements 48 that run parallel to one another and are aligned in the longitudinal direction L. At least three of these stiffening elements 48 extend from the second flank 44 to the blocking member 38, thereby making contact with an internal face of the push button 32. It will thus be understood that the stiffening elements 48 participate in connecting this blocking member 38 to the tab 34. The stiffening elements 48 have a parallelepipedal shape in a vertical-transverse plane, a vertical dimension of these stiffening elements 48 measured at the junction with the second flank 44 being less than a vertical dimension measured at the junction with the blocking member 38.

Thus, the present invention provides an adapter for a wiper system, a tab of which has, because of its configuration with two flanks connected by a bent portion, a small bulk, while ensuring the usability and strength expected from such an adapter.

However, the present invention is not limited to the means and configurations described and shown here, it also extending to any equivalent means and configuration and to any technically operational combination of such means.

1. An adapter for attaching a wiper blade to a drive arm of a wiper system, comprising a locking device configured to lock or unlock the adapter with respect to the drive arm and a push button borne by a tab, wherein the tab has in cross section at least two flanks connected to each other by a bent portion.

2. The adapter according to claim 1, wherein the at least two flanks that are joined by the bent portion.

3. The adapter according to claim 1, wherein the adapter mainly extends in a longitudinal direction, with an axis of rotation of the push button being parallel to the longitudinal direction.

4. The adapter according to claim 3, wherein flanks of the tab predominantly extend in the longitudinal direction.

5. The adapter according to claim 1, further comprises a receiving housing configured to receive the drive arm, the push button being off-center with respect to a median longitudinal axis of the receiving housing.

6. The adapter according to claim 5, further comprising a receiving cavity configured to receive a connector, the receiving housing configured to receive the drive arm being off-center with respect to the receiving cavity.

7. The adapter according to claim 1, wherein the tab protrudes from an edge of an opening present in a top wall of the adapter and into which the push button extends.

8. The adapter according to any claim 1, wherein the push button is interposed transversely between the bent portion and a constituent blocking member of the locking device and is configured to block the drive arm with respect to the adapter.

9. The adapter according to claim 8, further comprising at least one stiffening element extending at least between one of the flanks and the blocking member.

10. The adapter according to claim 1, wherein the tab has longitudinal dimensions of between 10 and 30 mm and transverse dimensions of between 2 and 5 mm, the adapter having longitudinal dimensions of between 70 and 150 mm and transverse dimensions of between 20 and 60 mm.

11. The adapter according to any claim 1, wherein the tab, the push button and a main body of the adapter are integral made of the same material.

12. A wiper system comprising a drive arm, a wiper blade, a connector and an adapter, wherein the adapter includes a locking device configured to lock or unlock the adapter with respect to the drive arm and a push button borne by a tab, wherein the tab has in cross section at least two flanks connected to each other by a bent portion.
